(19) United States
(12) Patent Application Publication
(10) Pub. No.: US 2004/0192196 A1
(43) Pub. Date: Sep. 30, 2004

(54) Method and apparatus for establishing a clear sky reference value

(76) Inventors: In-Kyung Kim, N. Potomac, MD (US); Russell Fang, Potomac, MD (US); Nate Schley, Walkersville, MD (US)

Correspondence Address: Hughes Electronics Corporation, Patent Docket Administration, Bldg.1, Mail Stop A109, P.O. Box 956, El Segundo, CA, 90245-0956, US

(21) Appl. No.: 10/401,088

(22) Filed: Mar. 27, 2003

(51) Int. Cl. H04B 7/185

(52) U.S. Cl. 455/12.1; 455/505

(57) ABSTRACT

A device for generating a reference value that represents a clear sky condition includes a receiver that receives beacon signals transmitted from a satellite. The device also includes logic that estimates carrier-to-noise levels associated with the beacon signals and uses the estimated carrier-to-noise levels to identify non-clear sky conditions. The logic also calculates the clear sky reference value using a portion of the estimated carrier-to-noise values, where the portion that is used excludes the estimated carrier-to-noise values taken during non-clear sky conditions.

### BACKGROUND OF THE INVENTION

1. Field of the Invention

The present invention relates generally to satellite communications and, more particularly, to establishing a clear sky carrier-to-noise reference value for use in satellite communications.

2. Description of Related Art

In satellite communications, a satellite periodically transmits a beacon signal to earth-based satellite terminals. Each satellite terminal determines the carrier-to-noise (C/N) ratio for the beacon signal. The C/N values determined over a period of time may then be used to estimate a clear sky C/N reference value. For example, in a conventional satellite terminal, the C/N values determined over a period of time may be filtered to generate a value that represents a clear sky C/N reference value.

One problem with estimating the clear sky C/N reference value in this manner occurs during long periods of rain, such as periods of several hours or more. In this case, the estimated clear sky C/N value tends to have a bias since it may take the filter a very long time before its output converges to the true clear sky C/N value. In other words, the C/N values taken during periods of rain do not provide a true indicator of the clear sky C/N value and adversely affect the estimated clear sky C/N value. An erroneous clear sky C/N reference value may cause problems associated with satellite communications.

For example, the beacon clear sky C/N reference value may be used to estimate downlink fade. The downlink fade estimates taken using an erroneous clear sky C/N reference may cause performance degradation associated with communications from/to the satellite. This performance degradation may be manifested in many ways. For example, in downlink power control (DLPC) related processing, the performance degradation may result in a link outage.

Therefore, a need exists for systems and methods that reduce problems associated with establishing a clear sky C/N reference value.

### SUMMARY OF THE INVENTION

Systems and methods consistent with the present invention address these and other needs by using a long term filter and a short term filter to estimate the clear sky C/N ratio. The short term filter may be used to detect periods of rain or other non-clear sky conditions. C/N values taken during these periods may then be excluded from contributing to estimates for establishing the clear sky C/N value. The long term filter may also be initialized with a value that permits the long term filter to converge to the clear sky C/N value.

In accordance with the principles of the invention as embodied and broadly described herein, a device that includes a receiver and at least one logic device is provided. The receiver is configured to receive beacon signals transmitted from a satellite and the logic device is coupled to the receiver. The logic device includes a C/N calculator, a first filter, a second filter and a comparator. The C/N calculator is configured to calculate a C/N values associated with the beacon signals and the first filter is configured to filter the C/N values associated with the beacon signals to generate an output. The second filter is configured with an initial value and the comparator is configured to determine a difference between an output of the second filter and the output of the first filter and provide the output from the first filter as input to the second filter when the difference is less than a threshold value.

In another implementation consistent with the present invention, a computer-readable medium having stored sequences of instructions is provided. The instructions when executed by at least one processor cause the processor to receive a number of C/N values and filter the C/N values to generate a first value representing an output from a first filter. The instructions also cause the processor to generate a second value representing an output from a second filter and compare the first and second values at predetermined intervals. The instructions further cause the processor to determine whether to use the output from the first filter to generate a C/N value representing a clear sky C/N value based on a result of the comparison.

In still another implementation consistent with the present invention, a method for generating a reference value representing a clear sky C/N value is provided. The method includes receiving a number of beacon signals at an earth-based terminal and estimating C/N values associated with the beacon signals. The method also includes filtering the C/N values to generate a first output and determining if the first output is within a predetermined range of a threshold value. The method further includes excluding the estimated C/N values for a period of time from contributing to a clear sky C/N calculation if the first output is not within the predetermined range of the threshold value.

In a further implementation consistent with the present invention, a method of generating an initial C/N value used in estimating a clear sky C/N value is provided. The method includes determining a link budget for transmissions from a satellite to a plurality of earth-based terminals, where the link budget is based on a carrier level associated with transmissions from the satellite to the earth-based terminals and at least one of a noise level and interference level associated with transmissions from the satellite to the earth-based terminals. The method also includes subtracting a predetermined value from the link budget to generate the initial value.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram of an exemplary network in which methods and systems consistent with the present invention may be implemented;

FIG. 2 is a diagram of an exemplary satellite terminal of FIG. 1 in an implementation consistent with the present invention;

FIG. 3 is a block diagram illustrating exemplary functional logic blocks implemented in the satellite terminal of FIG. 2 in an implementation consistent with the present invention;

FIG. 4 is a block diagram illustrating the operation of the short term filter and long term filter of FIG. 3 in an implementation consistent with the present invention;

FIG. 5 is a flow diagram illustrating exemplary processing associated with estimating a clear sky C/N reference value in an implementation consistent with the present invention;

FIG. 6 is a flow diagram illustrating exemplary processing associated with initializing the long term filter of FIG. 3 is an implementation consistent with the present invention; and

FIG. 7 is a flow diagram illustrating exemplary processing for reporting information to the network operations center of FIG. 1 in an implementation consistent with the present invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Systems and methods consistent with the present invention identify non-clear sky conditions. C/N measurements taken during these periods may then be excluded from calculations for estimating a clear sky C/N value.

### Exemplary Network

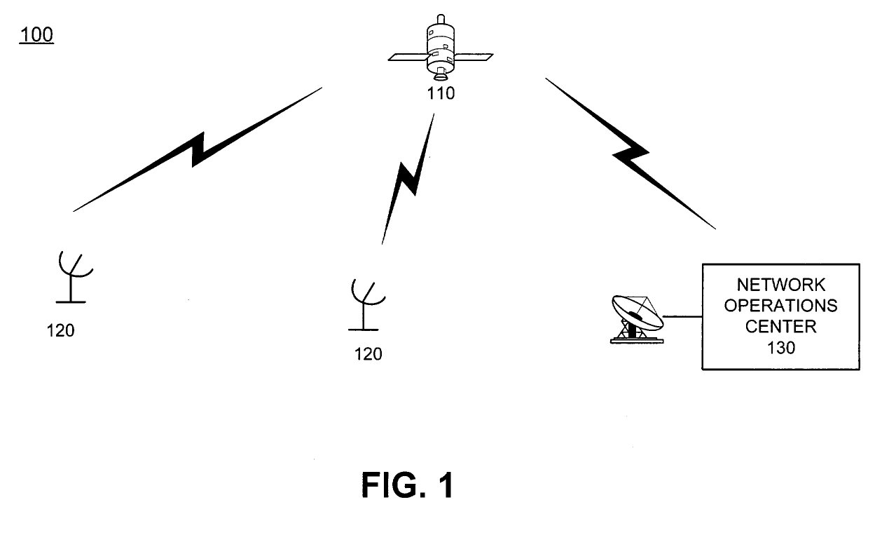

FIG. 1 illustrates an exemplary network which methods and systems consistent with the present invention may be implemented. Network 100 includes a satellite 110, a number of satellite terminals 120 (also referred to as terminals 120) and a network operations center 130. The number of components illustrated in FIG. 1 is provided for simplicity. It will be appreciated that a typical network 100 may include more or fewer components than are illustrated in FIG. 1.

Satellite 110 may support two-way communications with earth-based stations, such as satellite terminals 120 and network operations center 130. Satellite 110 may include one or more downlink antennas and one or more uplink antennas for transmitting data to and receiving data from earth-based stations, such as satellite terminals 120 and network operations center 130. Satellite 110 may also include transmit circuitry to permit the satellite 110 to use the downlink antenna(s) to transmit data using various ranges of frequencies. For example, satellite 110 may transmit data in the Ka frequency band ranging from about 17-31 GHz. Satellite 110 may also support transmissions in other frequency ranges. Satellite 110 via its uplink antenna(s), may receive uplink information transmitted on any number of frequencies from the earth-based stations.

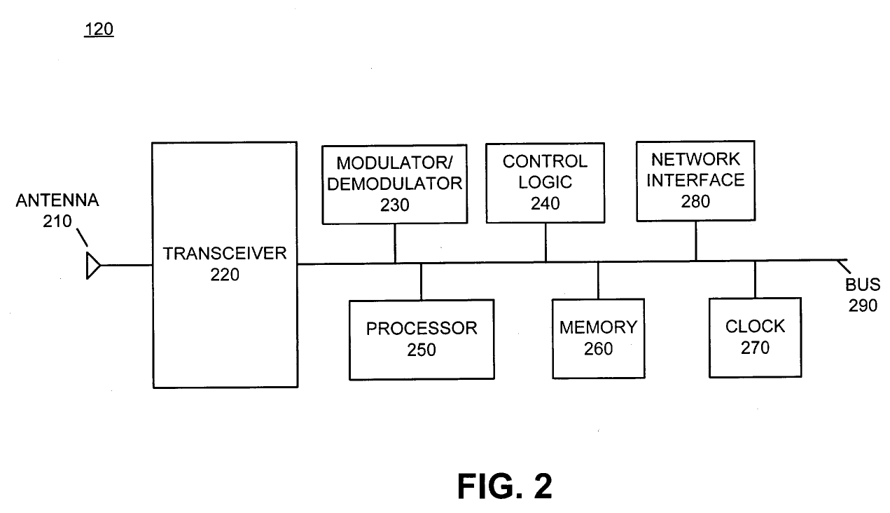

Satellite terminals 120 allow users to receive information transmitted via satellite 110 such as television programming, Internet data, etc., and to transmit information to other earth-based stations via satellite 110. FIG. 2 illustrates an exemplary configuration of a satellite terminal 120 consistent with the present invention. Referring to FIG. 2, satellite terminal 120 includes antenna 210, transceiver 220, modulator/demodulator 230, control logic 240, processor 250, memory 260, clock 270, network interface 280 and bus 290.

Antenna 210 may include one or more conventional antennas capable of transmitting/receiving signals via radio waves. For example, antenna 210 may receive data transmitted from satellite 110 in the Ka frequency band. Antenna 210 may also receive information transmitted in other frequency bands. Antenna 210 may also transmit data from satellite terminal 120 to satellite 110 using any number of frequencies.

Transceiver 220 may include well-known transmitter and receiver circuitry for transmitting and/or receiving data in a network, such as network 100. Modulator/demodulator 230 may include conventional circuitry that combines data signals with carrier signals via modulation and extracts data signals from carrier signals via demodulation. Modulator/demodulator 230 may also include conventional components that convert analog signals to digital signals, and vice versa, for communicating with other devices in terminal 120. Modulator/demodulator 230 may further include circuitry for measuring the power level associated with a beacon signal transmitted from satellite 110 as described in detail below.

Control logic 240 may include one or more logic devices, such as an application specific integrated circuit (ASIC), that control the operation of terminal 120. For example, control logic 240 may include logic circuitry used to determine a clear sky C/N reference value, as described in more detail below. Processor 250 may include one or more conventional processors or microprocessors that interprets and executes instructions. Processor 250 may perform data processing functions relating to establishing a clear sky C/N reference value, as described in more detail below.

Memory 260 may provide permanent, semi-permanent, or temporary working storage of data and instructions for use by processor 250 in performing processing functions. Memory 260 may include a conventional random access memory (RAM) or another dynamic storage device that stores information and instructions for execution by processor 250. Memory 260 may also include a conventional read only memory (ROM), an electrically erasable programmable read only memory (EEPROM) or another static or non-volatile storage device that stores instructions and information for use by processor 250. Memory 260 may further include a large-capacity storage device, such as a magnetic and/or optical recording medium and its corresponding drive.

Clock 270 may include conventional circuitry for performing timing-related operations associated with one or more functions performed by terminal 120. Clock 270 may include, for example, one or more counters.

Network interface 280 may include an interface that allows terminal 120 to be coupled to an external network. For example, network interface 280 may include a serial line interface, an Ethernet interface for communicating to a local area network (LAN), an asynchronous transfer mode (ATM) network interface and/or an interface to a cable network. Alternatively, network interface 280 may include other mechanisms for communicating with other devices and/or systems.

Bus 290 may include one or more conventional buses that interconnect the various components of terminal 120 to permit the components to communicate with one another. The configuration of terminal 120, shown in FIG. 2, is provided for illustrative purposes only. One skilled in the art will recognize that other configurations may be employed. Moreover, one skilled in the art will appreciate that a typical terminal 120 may include other devices that aid in the reception, transmission, or processing of data.

Terminal 120, consistent with the present invention, performs processing relating to determining a clear sky C/N reference value. The terminal 120 may perform such processing, described in detail below, in response to processor 250 executing sequences of instructions contained in a computer-readable medium, such as memory 260. It should be understood that a computer-readable medium may include one or more memory devices and/or carrier waves. The instructions may be read into memory 260 from another computer-readable medium or from a separate device via network interface 280. Execution of the sequences of instructions contained in memory 260 causes processor 250 to perform the process steps that will be described hereafter. In alternative embodiments, hard-wired circuitry may be used in place of or in combination with software instructions to implement the present invention. For example, control logic 240 and/or modulator/demodulator 230 may perform one or more of the processes described below. In still other alternatives, various acts may be performed manually, without the use of terminal 120. Thus, the present invention is not limited to any specific combination of hardware circuitry and software.

Referring back to FIG. 1, network operations center 130 may perform resource management services associated with network 100. For example, network operations center 130 may transmit data to and receive data from terminals 120 via satellite 110. Network operations center 130 may also control operations of satellite 110. For example, network operations center 130 may transmit uplink information to satellite 110 regarding downlink power control, as described in more detail below.

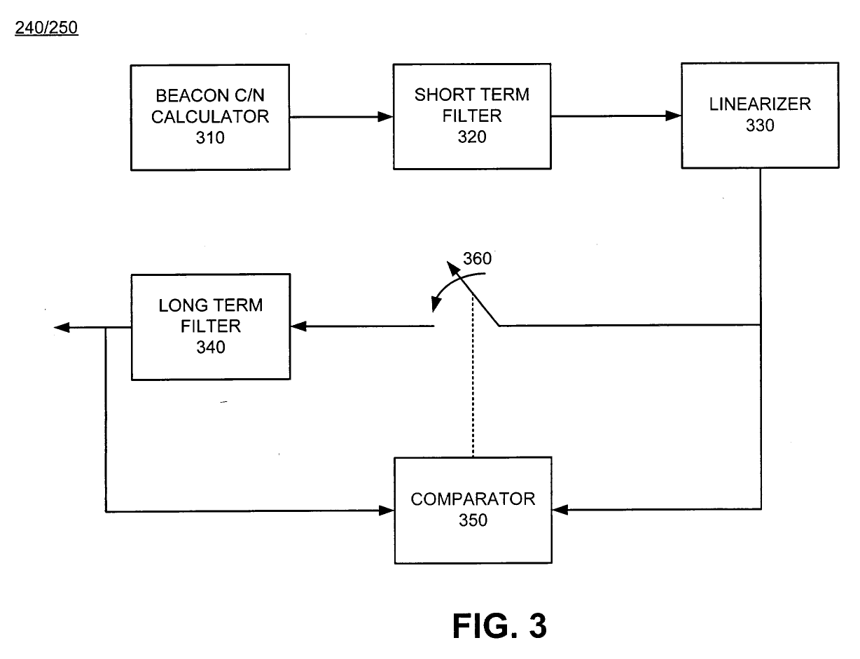

FIG. 3 is a functional block diagram illustrating logic for establishing a clear sky C/N reference value according to an implementation consistent with the present invention. Referring to FIG. 3, beacon calculator 310, short term filter 320, linearizer 330, long term filter 340, comparator 350 and switch 360 may be implemented in control logic 240 and/or by processor 250 executing instructions stored in memory 260 and/or by other devices in terminal 120.

Beacon C/N calculator 310 may receive a beacon signal from satellite 110 and calculate the C/N value associated with the beacon signal (also referred to as signal-to-noise ratio (SNR)). For example, satellite 110 may transmit a beacon signal every predetermined period of time, such as every 3 milliseconds (ms). The beacon signal may be used by terminals 120 to facilitate establishing communications with satellite 110. Beacon C/N calculator 310 may determine the C/N ratio for the received beacon signals. For example, in one implementation consistent with the present invention, beacon C/N calculator 310 may measure/estimate the SNR using equation 1 below.

$$SNR = \frac{{P}_{s}}{\vert RSS - {P}_{s} \vert} , \qquad Equation ( 1 )$$

where Pₛ represents the estimated signal power and the received signal strength (RSS) represents the total power of the received signal (i.e., the sum of the signal power (Pₛ) and the noise power (Pₙ)). RSS, consistent with the present invention, may be defined by equation 2 below.

$$RSS = \frac{1}{N} {\sum }_{i = 0}^{N - 1} {\vert {r}_{i} \vert}^{2} \approx {P}_{s} + {P}_{n} , \qquad Equation ( 2 )$$

where N=total number of samples and rᵢ=sᵢ+nᵢ, where rᵢ represents the received signal at sample i, sᵢ represents the signal power at sample i and nᵢ represents the random noise at sample i. Pₛ, consistent with the present invention, may be defined by equation 3 below.

$${P}_{s} \approx {\vert \frac{1}{N} {\sum }_{i = 0}^{N - 1} {r}_{i} \vert}^{2} \qquad Equation ( 3 )$$

In this manner, beacon C/N calculator 310 may calculate the C/N value (i.e., the SNR) for the beacon signal. In some implementations, the signal power estimate Pₛ may be divided over L segments to desensitize performance loss against frequency offset. In alternative implementations, other known processes for estimating/measuring the C/N ratio may be used.

Short term filter 320 may be used to average or filter the C/N values measured over a period of time. For example, short term filter 320 may receive the beacon C/N values and filter the C/N values over a relatively short time period. Short term filter 320 may use any number of filtering/averaging processes to filter the C/N values. In an exemplary implementation, short term filter 320 may be an infinite impulse response (IIR) type filter. In an IIR filter, each sample of an output is the weighted sum of past and current samples of input.

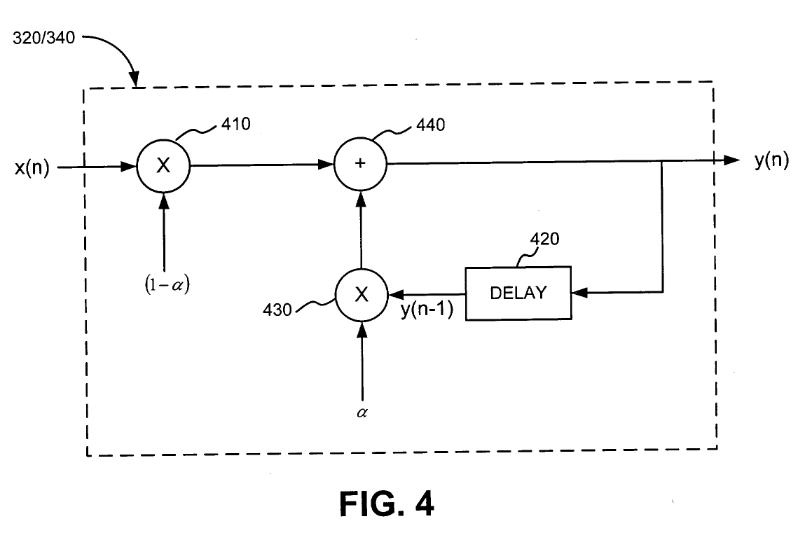

FIG. 4 is an exemplary functional diagram illustrating short term filter 320. Referring to FIG. 4, x(n) represents C/N values input to filter 320 at time “n” and y(n) represents an output of filter 320 at time n. The x(n) input values and the quantity (1−α) are multiplied by multiplier 410, where α represents a filter coefficient. The output y(n) is input to a delay element 420, thereby producing the delayed value y(n−1). The delayed value y(n−1) and the filter coefficient α are multiplied by multiplier 430. The output of multipliers 410 and 430 are then summed by adder 440. In summary, the output of filter 320 can be represented by equation 4 below.

y(n)=αy(n−1)+(1−α)x(n) Equation (4)

In an exemplary implementation, the filter coefficient α may be computed using equation 5 below.

α=1−(Tₛ/τ) Equation (5),

where Tₛ represents a sampling rate of filter 320 and τ represents a time constant of filter 320. The sampling rate Tₛ for short term filter 320 may range from about 3 to 300 milliseconds and the value of τ may range from about 1-300 seconds. In an exemplary implementation the sampling rate Tₛ may be 96 ms and the time constant τ may be 20 seconds. In this implementation, the value of α may be equal to 1−(0.096 s/20 s) or 0.9952.

Long term filter 340 may be configured in a similar manner as short term filter 320. That is, long term filter 340 may be a single pole IIR type filter as illustrated in FIG. 4, with the output represented by equation 4 above. The sampling rate and time constant of long term filter 340 may be significantly longer than those of short term filter 320. For example, the sampling rate Tₛ for long term filter 340 may range from about 10 to 20 seconds and the value of τ may range from about 2 hours to 10 days. In an exemplary implementation, the sampling rate Tₛ may be 10 seconds and the time constant τ may be seven days for long term filter 340. In this implementation, the value of α is equal to 1−(10 s/(7 days×24 hours/day×3600 s/hour) or 0.99998349. Since long term filter 340 has a large time constant (e.g., 7 days), the sampling rate of 10 seconds provides stable performance for long term filter 340.

As described above, the sampling rate of short term filter 320 may be 96 ms. This value may coincide with the uplink frame time or the frequency of an uplink message used by terminal 120 to transmit information to satellite 110. It should be understood that other sampling rates and time constants may be used for short term filter 320 and long term filter 340 in implementations consistent with the present invention. In each case, however, the short term filter 320 outputs values representing short term effects on the C/N level, such as rainy weather, as described in more detail below.

Referring back to FIG. 3, linearizer 330 may receive the output from short term filter 320 and linearize the output. For example, linearizer 320 may receive a number of values output from short term filter 320 over a period of time, such as 10 seconds. Linearizer 330 may remove the bias associated with measurements having higher C/N values. In an exemplary implementation, linearizer 330 may linearize the C/N values received from short term filter 320 using equation 6 below.

y=a₀+a₁x+a₂x²+a₃x³+a₄x⁴+a₅x⁵ Equation (6),

where y represents the linearized output, x represents the input C/N values and a₀-a₅ represent coefficient values. In an exemplary implementation, a₀ may be 1.5124×10⁻¹, a₁ may be 1.0109, a₂ may be 1.3642×10⁻³, a₃ may be 4.1387×10⁻⁴, a₄ may be −4.9854×10⁻⁵, and a₅ may be 2.4539×10⁻⁶. Other values for a₀-a₅ may be used in alternative implementations of the present invention. The coefficient values a₀-a₅ may also be configurable via, for example, a message from network operations center 130. That is, network operations center 130 can change the values of coefficients a₀-a₅ by transmitting a configuration data announcement command to terminals 120. In summary, linearizer 330 compensates for the distortion/error introduced by modulator/demodulator 230 and/or control logic 240 in estimating the C/N value for the beacon signals

Comparator 350 may receive the output from long term filter 340 and short term filter 320 (via linearizer 330) and compare the outputs to determine a difference. More particularly, comparator 350 may subtract the output of linearizer 330 from the output of long term filter 340 to determine a difference or delta between the C/N values (i.e., ΔC/N, also referred to as ΔSNR). If the difference is less than a threshold value, comparator 350 closes switch 360. In an exemplary implementation consistent with the present invention, the threshold value may be 0.5 dB. Comparator 350 may compare the output of long term filter 340 and short term filter 320 every predetermined period of time, e.g., every 10 seconds to determine whether switch 360 is to be closed or opened. When the ΔC/N value is less than the threshold value, switch 360 is closed and the beacon C/N values will be input to long term filter 340 to contribute to determining a clear sky C/N reference value. When the ΔC/N value is greater than the threshold value, switch 360 is opened and the beacon C/N values will not be input to long term filter 340 and will not contribute to determining a clear sky C/N reference value.

As described previously, the functional blocks in FIG. 3 may be implemented in hardware, software or combinations of hardware and software. In one implementation, beacon C/N calculator 310 may be implemented in hardware, such as control logic 240 and/or modulator/demodulator hardware 230. Control logic 240 and modulator/demodulator may be implemented, for example, in one or more ASIC devices. The other functional blocks in FIG. 3 may be implemented by processor 250 (FIG. 2) executing sequences of instructions stored in memory 260. It should be understood, however, that the functional blocks illustrated in FIG. 3 may alternatively be implemented in other combinations of hardware/software.

### Exemplary Processing

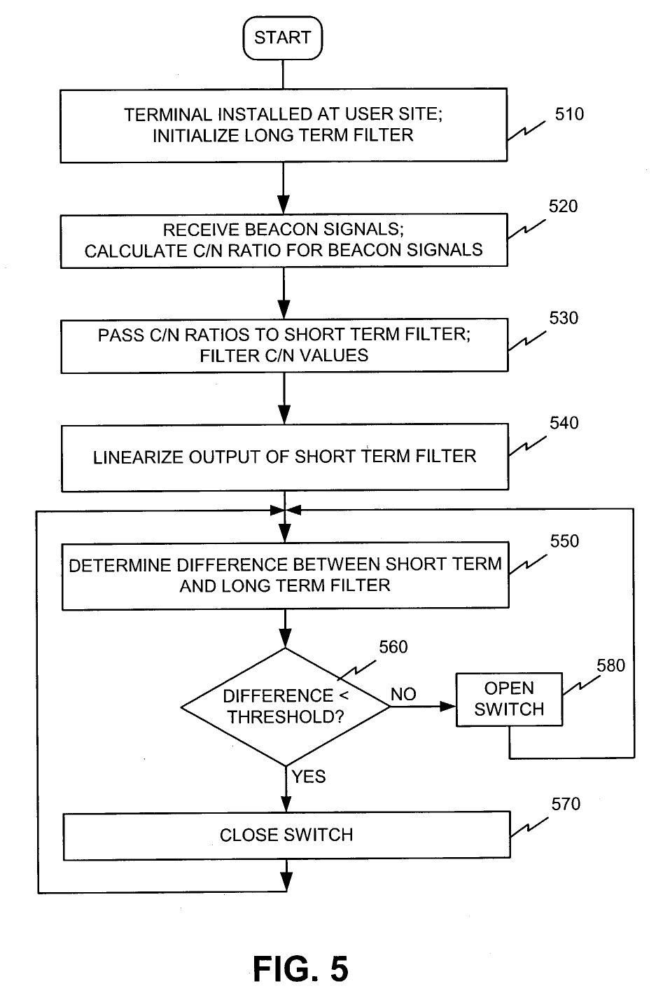

FIG. 5 illustrates exemplary processing consistent with the present invention for establishing a clear sky C/N reference value. The clear sky C/N reference value may then be used to facilitate downlink power control related processing. Processing may begin when terminal 120 is installed at a user site and powers on for the first time (act 510). After terminal 120 powers, long term filter 340 may be initialized (act 510). Long term filter 340 may be initialized with a value stored in non-volatile memory, such as memory 260 (FIG. 2). The particular value may be stored in non-volatile memory at the time terminal 120 is manufactured. In other implementations, long term filter 340 may be initialized when terminal 120 is installed at a user site with a value transmitted from network operations center 130 via satellite 110. In either case, the initial value of long term filter 340 may be selected such that the value is below an expected clear sky C/N reference value, as described in more detail below. In an exemplary implementation, long term filter 340 may be initialized with a value of 5.5 dB. Other values may also be used in alternative implementations.

Terminal 120 continues with an initialization process to establish communication with satellite 110. For example, as described previously, satellite 110 may transmit a beacon signal every predetermined period of time. The beacon signal may be used by all receiving terminals to aid in the initialization process associated with receiving data from satellite 110. Assume that terminal 120 receives the beacon signal from satellite 110 every predetermined period of time (act 520). Beacon C/N calculator 310 may then determine the C/N value for the received beacon signals (act 520). More particularly, beacon C/N calculator 310 may measure/estimate the SNR of the beacon signals using equations 1-3 discussed above. In alternative implementations, other known processes for estimating/measuring the SNR may be used. Beacon C/N calculator 310 may make this measurement every predetermined period of time, such as every 96 ms. Alternatively, beacon calculator 310 may make C/N measurements at other predetermined intervals and other known processes for estimating/measuring the C/N value may be used.

Beacon C/N calculator 310 forwards the C/N values to short term filter 320. Short term filter 320 may then average or filter the received C/N values (act 530). More particularly, in an exemplary implementation consistent with the present invention, short term filter 320 applies an IIR type filtering process to filter the C/N values, as described above with respect to FIG. 4. For example, as discussed previously, short term filter 320 may filter the input values x(n) to produce an output y(n) represented by equation 4 above. As described above with respect to FIG. 4, in an exemplary implementation, the time constant τ of short term filter 320 may be 20 seconds and the sampling rate Tₛ may be 96 ms (i.e., the rate at which short term filter 320 is supplied with C/N values from beacon C/N calculator 310), with the filter coefficient being 0.9952. This sampling rate and time constant allow short term filter 320 to filter C/N values over a relatively short time period.

Short term filter 320 may then output the results of the filtering to linearizer 330. Linearizer 330 may linearize a number of C/N values output from short term filter 320 to remove the distortion or bias associated with C/N measurements having higher C/N values (act 540). In an exemplary implementation consistent with the present invention, linearizer 330 may sample the output of short term filter 320 every predetermined period of time, such as every 10 seconds. Linearizer 330 may then linearize these samples using equation 6 above.

In some implementations, linearizer 330 may not be needed and the output of short term filter 320 may be input directly to comparator 350. For example, if the C/N values do not exhibit distortion or compression as a result of the C/N measuring logic, linearizer 330 may be bypassed.

In either case, comparator 350 receives the output of long term filter 340 and the output from short term filter 320 (either via linearizer 330 or directly). Comparator 350 may then determine the difference between these values to generate a ΔC/N value (act 550). In an exemplary implementation, comparator 350 may subtract the current output of short term filter 320 (linearized output if linearizer 330 is used) from the current output of long term filter 340 every predetermined period of time, such as every 10 seconds. In alternative implementations, the predetermined period of time may be shorter or longer.

Comparator 350 may also determine whether the difference between the current output of the long term filter 340 and the current output of the short term filter 320 is less than a predetermined threshold (act 560). In an exemplary implementation, the threshold is 0.5 dB. Other threshold values may be used in alternative implementations. If the ΔC/N value is less than the threshold value, switch 360 may be closed (act 570). In this case, the output of short term filter 320 (via linearizer 330 if appropriate) may be fed to the input of long term filter 340. In other words, the beacon C/N values from short term filter 320 may be used by long term filter 340 to generate the clear sky C/N value. In this manner, the current beacon C/N values are used to determine the clear sky C/N value. The process may then return to act 550, where the processing is repeated every predetermined interval, e.g., every 10 seconds.

If the ΔC/N value is not less than the threshold value, switch 360 is opened or remains open (act 580). In this case, C/N measurements from short term filter 320 are not input to long term filter 340. The process may then return to act 550 and the processing repeats. In this manner, beacon measurements that have a have a relatively low C/N ratio are not fed to long term filter 340 and are therefore not used in generating the clear sky reference value. Such low C/N values may represent C/N values taken under rainy skies. As such, these values would not represent actual clear sky conditions and would lower the clear sky C/N value output from long term filter 340 in an erroneous manner. After a predetermined period of time, during which switch 360 may be closed and opened any number of times, the output of long term filter 340 will converge to the value that represents the clear sky C/N level.

In an exemplary implementation consistent with the present invention, the ΔC/N values is computed each time the long term filter's 340 output is sampled, e.g., every 10 seconds. The latest ΔC/N values may also be sent to the network operations center 130 for use in downlink power control, as described in more detail below. In addition, the most recent output from long term filter 340 may be stored in non-volatile memory, such as memory 250. In this manner, if terminal 120 powers down for some period of time after installation of terminal 120, the current value of long term filter 340 is preserved in non-volatile memory. This current value of long term filter 340 value is then used as the clear sky reference value upon re-starting of terminal 120. In other words, if terminal 120 powers down for some reason, the initial value of long term filter 340 does not revert back to the initial value used at the time of installation of terminal 120 (described with respect to act 510 above). The operation of long term filter 340 merely re-starts with the most recent value output from long term filter 340 being used as the current clear sky C/N value.

As described above, comparator 350 may compare the output of long term filter 340 and short term filter 320 every predetermined period of time, such as every 10 seconds to generate ΔC/N values. Long term filter 340, consistent with the present invention, may be initialized upon terminal installation at a user site with a value that facilitates the long term filter's 340 convergence to the true clear sky C/N reference value in a reasonable period of time, such as 30 days, as described in more detail below.

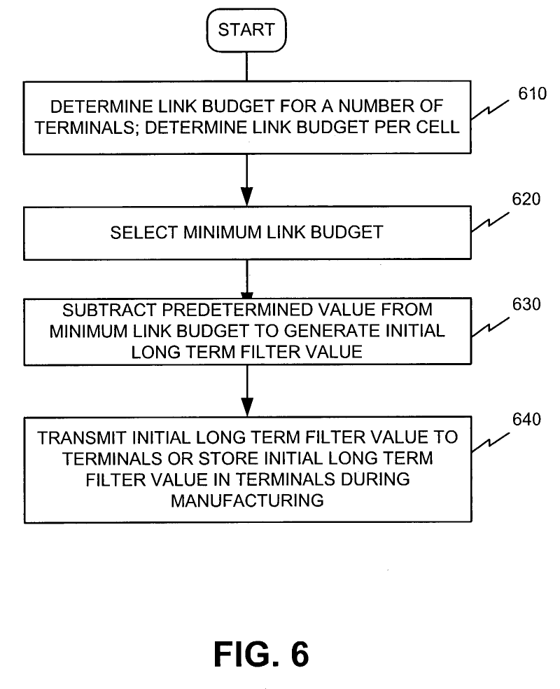

FIG. 6 illustrates exemplary processing consistent with the present invention for determining an initial value for long term filter 340 upon installation of terminal 120. Processing may begin by determining a link budget associated with downlink transmissions from satellite 110 to terminals 120 (act 610). The link budget for each terminal may be represented by equation 7 below.

Link budget=C/(N+I) Equation (7),

where C represents the carrier power level (i.e., beacon power level), N represents the noise level and I represents an interference level. The interference may include interference from signals transmitted from other radio systems or interference caused by transmissions from terminal 120 intended for other terminals. The carrier, noise and interference levels may be based on typical data taken from a number of satellite terminals 120 or system design parameters.

A link budget per cell area may also be determined (act 610). The link budget per cell may be determined for a worst case signal reception. That is, the antenna pattern may vary within a cell and the signal strength received by a terminal 120 in the center of a cell area may be greater than a terminal 120 on the edge of a cell area. The link budget per cell may take the lowest link budget from terminals 120 within each cell.

The minimum link budget for all the cells may then be selected (act 620). That is, the smallest link budget determined over all the cells may be selected. For example, the link budget for a cell in the New York area may be 0.2 dB less than the link budget for a cell in the Washington D.C. area. In this situation, the cell with the smallest link budget (i.e., the New York cell) is selected. In an exemplary implementation consistent with the present invention, the minimum link budget over all the cells associated with transmissions from satellite 110 may be 7.5 dB

After determining the minimum link budget, a predetermined value may be subtracted from the minimum link budget (act 630). Subtracting the predetermined value accounts for variations in manufacturing associated with different types of satellite terminals 120. For example, one type of terminal 120 may include better antenna/receiver circuitry that enables the terminal to receive a stronger carrier signal than another type of terminal 120. To compensate for variations in terminals 120, the predetermined value may range from 1-3 dB. In an exemplary implementation, the predetermined value may be 2 dB and the initial value of long term filter 340 may be 7.5 dB-2 dB or 5.5 dB. Subtracting a predetermined value, such as 2 dB, ensures that each of the terminals 120 will be initialized upon installation of the terminals 120 at user sites with a value that is below the true clear sky C/N value, but enables long term filter 340 to converge to the true clear sky C/N value in a reasonable amount of time. Selecting the minimum link budget and then subtracting the predetermined value also ensures that the initial value of long term filter 340 does not render switch 360 irrelevant. In other words, if the initial value used for long term filter 340 at the installation of terminal 120 is set too high, switch 360 may remain open during periods in which it should be closed.

After determining the initial value of long term filter 340, the initial value may be transmitted to terminal 120 during the installation of terminal 120 (act 640). For example, network operations center 130 may transmit the initialization value to terminals 120 via a configuration command. In alternative implementations, the initial value for long term filter determined at act 630 may be prestored in non-volatile memory, such as memory 260, prior to installation of terminal 120 at a user's location (e.g., during manufacturing of terminal 120) (act 640). In either case, initializing the long term filter 340 in each of satellite terminals 120 with the same value over all the cells simplifies the procedure for configuring satellite terminals 120 for installation and use. In other implementations, a different initial value for long term filter 340 for each cell and/or terminal type (or equivalent antenna size or antenna gain-to-system noise temperature (G/T) value) may be used. In this case, however, the terminals 120 would have to be initialized based on the particular cell and/or terminal type in which the terminal 120 would be used. If a terminal type scheme is employed, multiple initialization values for a given cell may be required (e.g., different terminal types may be assigned with different values).

In the manner described above, each terminal 120 may be initialized with a value that aids in determining a clear sky C/N value. In an exemplary implementation consistent with the present invention, the clear sky C/N value may then be used to determine fade conditions, such as during periods of rain, and to facilitate downlink power control related processing, as described in more detail below.

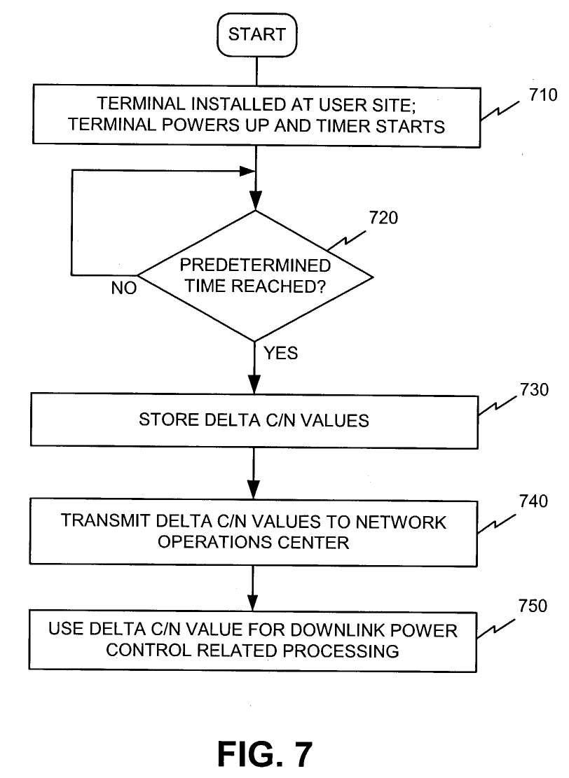

FIG. 7 illustrates exemplary processing relating to using the clear sky C/N values for downlink power control processing. Processing may begin upon initial installation of terminal 120 at a user site (act 710). Long term filter 340 may be initialized upon installation of terminal 120 as described above with respect to FIG. 6 and terminal 120 may begin receiving beacon signals. In addition, a timer may be started upon installation of terminal 120 and initial start-up using, for example, clock 270 (FIG. 2).

After terminal 120 is installed and initially starts up, it may take a period of time for the long term filter 340 to converge to the true clear sky C/N value. Therefore, each terminal 120 may be prohibited from sending ΔC/N values to other devices in network 100, such as network operations center 130, until a predetermined period of time has expired after initial start-up. In an exemplary implementation consistent with the present invention, the timer may be set to 30 days. In alternative implementations, the timer may be set to other values. In each case, terminal 120 may determine whether its timer has reached the predetermined time value (act 720). If the timer has not reached the predetermined time value, terminal 120 may not transmit ΔC/N values to network operations center 130, even if network operations center 130 transmits a command requesting such values. During this time, however, long term filter 340 continues to operate as described above with respect to FIG. 4. Preventing terminal 120 from transmitting ΔC/N values for a period of time until long term filter 340 converges to a value close to the true clear sky C/N value prevents network operations center 130 from using ΔC/N values that do not accurately represent the true deviation from the clear sky C/N value.

The current value of the timer may be stored in non-volatile memory, such as memory 260. If terminal 120 powers down for some reason after initial installation, which may typically occur at least once during a 30 day period, the timer restarts with the value stored in the non-volatile memory and does not restart from zero. This enables terminal 120 to participate in downlink power control related processing after the predetermined amount of operating time has been reached.

If the timer has reached the predetermined time value, terminal 120 may store the ΔC/N values generated by comparator 350 (act 730). That is, comparator 350 compares the output of long term filter 340 and short term filter 320 (via linearizer 330, if appropriate) every predetermined period of time, such as every 10 seconds, regardless of whether switch 360 is opened or closed, to generate ΔC/N values. Terminal 120 may transmit the ΔC/N values generated by comparator 350 every predetermined period of time to network operations center 130 and/or in response to a polling message transmitted from network operations center 130 (act 740).

In either case, network operations center 130 receives the ΔC/N values from a number of terminals 120. Network operations center 130 may then use the ΔC/N data to identify fade conditions (i.e., conditions where the signal strength has been reduced due to rain or other non-clear sky conditions). Network operations center 130 may then use the data to signal satellite 110 to alter its downlink power level (act 750). For example, network operations center 130 may determine that fade in a particular cell area is a relatively deep fade (e.g., more than 1 dB). In this case, network operations center 130 may signal satellite 110 to increase the power level associated with transmitting downlink messages in that cell. In this manner, network operations center 130 is able to gain an accurate assessment of network conditions and is able to control satellite 110 according to the conditions.

Systems and methods consistent with the present invention identify non-clear sky conditions and exclude beacon C/N estimates taken during these non-clear sky periods from contributing to estimates for determining a clear sky C/N reference value. An advantage of the present invention is that a satellite terminal is able to converge to a clear sky C/N value in a reasonable period of time without adverse impact from periods of rain. The present invention also prevents ΔC/N values from being transmitted to an entity that performs downlink power control (DLPC) processing prior to the satellite terminal achieving a reference C/N value that represents the true clear sky value. This prevents an entity, such as network operations center 130, from performing erroneous DLPC related adjustments to the satellite.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. For example, while series of acts have been described with respect to FIGS. 5-7, the order of the acts may be modified in other implementations consistent with the present invention. Moreover, non-dependent acts may be performed in parallel. In addition, the present invention has been described as using particular equations to estimate the C/N values, filter the C/N values and linearize the filtered C/N values. It should be understood that other mathematical/statistical methods may also be used in other implementations of the invention.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed is:

1. A device, comprising:
a receiver configured to receive beacon signals transmitted from a satellite; and
at least one logic device coupled to the receiver and comprising:
a carrier-to-noise (C/N) calculator configured to calculate C/N values associated with the beacon signals,
a first filter configured to filter the C/N values associated with the beacon signals to generate an output,
a second filter configured with an initial value, and
a comparator configured to:
determine a difference between an output of the second filter and the output of the first filter, and
provide the output from the first filter as input to the second filter when the difference is less than a threshold value.

2. The device of claim 1, wherein the comparator is further configured to:
prevent the output from the first filter from being input to the second filter when the difference is not/less than the threshold value.

3. The device of claim 1, wherein the threshold value is 0.5 dB.

4. The device of claim 1, wherein the second filter is further configured to:
filter the output from the first filter input to the second filter, and
output a value representing a clear sky C/N value after a predetermined period of time.

5. The device of claim 4, wherein the initial value of the second filter is lower than an expected clear sky C/N value.

6. The device of claim 1, wherein the first filter and the second filter each comprise infinite impulse response type filters and a filter coefficient of the first filter is smaller than a filter coefficient of the second filter.

7. The device of claim 1, wherein the first filter represents a short term filter with respect to the second filter.

8. The device of claim 7, wherein the first filter has a time constant ranging from a period of about 1-300 seconds and the second filter has a time constant ranging from a period of about 2 hours to 10 days.

9. The device of claim 1, wherein the at least one logic device further comprises:
a linearizer configured to:
receive the output from the first filter,
linearize the output received over a predetermined period, and
provide the linearized output from the first filter to the comparator.

10. The device of claim 1, further comprising:
a transmitter coupled to the at least one logic device, and wherein the comparator is further configured to:
forward the difference between the output of the second filter and the output of the filter to the transmitter after a predetermined period of time, and wherein the transmitter is configured to:
transmit the difference at predetermined intervals to an entity associated with controlling the satellite.

11. The device of claim 1, further comprising:
a memory configured to store instructions, and wherein the at least one logic device comprises:
at least one processor, wherein at least the first filter, the second filter and the comparator are implemented by the at least one processor executing the instructions stored in the memory.

12. A method for generating a clear sky reference value, comprising:
receiving a plurality of beacon signals;
measuring a carrier-to-noise (C/N) value for each of the plurality of beacon signals;
inputting the C/N values to a first filter;
comparing an output of the first filter with an output of a second filter; and
providing the output from the first filter to the second filter based on a result of the comparing.

13. The method of claim 12, wherein the comparing includes:
determining a difference between the output of the second filter and the output of the first filter.

14. The method of claim 13, wherein the providing includes:
inputting the output from the first filter to the second filter when the difference is less than a threshold value.

15. The method of claim 14, wherein the threshold value is 0.5 dB.

16. The method of claim 12, wherein the comparing comprises:
comparing the output of the first filter with the output of the second filter at predetermined intervals, the method further comprising:
inputting the output from the first filter to the second filter when the comparing indicates that a difference between the outputs of the first and second filters is less than a predetermined value; and
filtering, by the second filter, the input from the first filter, wherein the output from the second filter taken after a predetermined period of time represents the clear sky reference value.

17. The method of claim 12, further comprising:
filtering, by the second filter, the output from the first filter using an infinite impulse response type filtering process.

18. The method of claim 12, wherein the first filter represents a short term filter with respect to the second filter and the first filter has a smaller filter coefficient value than the second filter.

19. The method of claim 12, further comprising:
initializing the second filter with a value below an expected clear sky reference value.

20. The method of claim 12, further comprising:
transmitting the difference between the output of the first filter and the output of the second filter after a predetermined period of time to an entity associated with controlling a power level with which the beacon signals are transmitted.

21. A computer-readable medium having stored thereon a plurality of sequences of instructions which, when executed by at least one processor, cause the at least one processor to:
receive a plurality of carrier-to-noise (C/N) values;
filter the plurality of C/N values to generate a first value representing an output from a first filter;
generate a second value representing an output from a second filter;
compare the first and second values at predetermined intervals; and
determine whether to use the output from the first filter to generate a C/N value representing a clear sky C/N value based on a result of the comparison.

22. The computer-readable medium of claim 21, wherein when comparing the first and second values at predetermined intervals, the instructions cause the at least one processor to:
calculate a difference between the first and second values.

23. The computer-readable medium of claim 22, wherein when determining whether to use the output from the first filter to generate the clear sky C/N value, the instructions cause the at least one processor to:
use the output from the first filter to generate the clear sky C/N value when the difference is less than a threshold value.

24. The computer-readable medium of claim 23, wherein the threshold value is 0.5 dB.

25. The computer-readable medium of claim 21, further including instructions for causing the at least one processor to:
input the output from the first filter to the second filter when a difference between the first and second values is less than a threshold value; and
filter the output from the first filter to generate an output value, wherein the output value taken after a predetermined period of time represents the clear sky C/N value.

26. The computer-readable medium of claim 21, wherein when filtering the plurality of C/N values, the instructions cause the at least one processor to:
filter the plurality of C/N values using an infinite impulse response type filtering process having a first filter coefficient.

27. The computer-readable medium of claim 26, wherein the instructions further cause the at least one processor to:
input the output from the first filter for a predetermined period of time to the second filter when a result of the comparison indicates that the first and second values are within a predetermined range of each other.

28. The computer-readable medium of claim 27, wherein the instructions further cause the at least one processor to:
filter the input to the second filter using an infinite impulse response type filtering process having a second filter coefficient, wherein the second filter coefficient is larger than the first filter coefficient.

29. The computer-readable medium of claim 28, wherein the first filter coefficient is based on a sampling rate and time constant that are shorter than a sampling rate and time constant of the second filter.

30. The computer-readable medium of claim 21, further including instructions for causing the at least one processor to:
initialize the second filter with a value lower than an expected clear sky C/N value.

31. A system for determining a reference value representing clear sky conditions, comprising:
means for receiving a plurality of beacon signals transmitted from a satellite;
means for determining carrier-to-noise (C/N) ratios associated with the plurality of beacon signals;
means for filtering the C/N ratios to generate first output values;
means for determining differences between the first output values and second output values at predetermined intervals; and
means for calculating the reference value using the C/N ratios for a predetermined duration when the means for determining determines that the difference between one of the first output values and one of the second output values is less than a threshold value.

32. The system of claim 31, wherein the means for calculating comprises:
means for filtering the first output values using a relatively long term filter, and
means for outputting the reference value after a predetermined period of time.

33. A device for generating a clear sky reference value, comprising:
a receiver configured to receive a plurality of beacon signals transmitted from a satellite; and
logic coupled to the receiver, the logic configured to:
estimate carrier-to-noise (C/N) values associated with the plurality of beacon signals,
identify non-clear sky conditions based on the estimated C/N values, and
calculate the clear sky reference value using at least a portion of the estimated C/N values, wherein the portion excludes estimated C/N values taken during non-clear sky conditions.

34. The device of claim 33, wherein when identifying non-clear sky conditions, the logic is configured to:
filter the estimated C/N values to generate an output,
compare the output to a first value to generate a difference, and
determine that a non-clear sky condition exists when the difference is greater than a threshold value.

35. The device of claim 34, wherein the first value represents an output of a long term filter initialized with a smaller value than an expected clear sky reference value.

36. The device of claim 33, further comprising:
a memory configured to store instructions, and wherein the logic comprises at least one processor configured to execute the stored instructions to identify non-clear sky conditions and calculate the clear sky reference value.

37. A method for generating a reference value representing a clear sky carrier-to-noise (C/N) value, comprising:
receiving a plurality of beacon signals at an earth-based terminal;
estimating a plurality of C/N values associated with the plurality of beacon signals;
filtering the plurality of C/N values to generate a first output;
determining if the first output is within a predetermined range of a threshold value; and
excluding the estimated C/N values for a period of time from contributing to a clear sky C/N calculation if the first output is not within the predetermined range of the threshold value.

38. The method of claim 37, further comprising:
calculating the clear sky C/N value using the estimated C/N values for the period of time if the first output is within the predetermined range of the threshold value.

39. The method of claim 37, wherein the first output represents an output from a first filtering process and the threshold value represents an output from a second filtering process, the method further comprising:
comparing the outputs from the first and second filtering processes at predetermined intervals to determine a difference at each predetermined interval; and
inputting the output from the first filtering process to the second filtering process after the determining determines that the first output is within the predetermined range of the output from the second filtering process.

40. The method of claim 39, further comprising:
repeating the comparing and inputting for a predetermined duration, wherein the output of the second filtering process after the predetermined duration represents the clear sky C/N value.

41. The method of claim 39, further comprising:
transmitting difference values at predetermined intervals to an entity associated with controlling a power level at which the beacon signals are transmitted, the difference values representing a difference between the clear sky C/N value and a current C/N value;
receiving, by the entity, the difference values from a number of earth-based terminals; and
using the difference values to identify a fade condition.

42. The method of claim 41, further comprising:
transmitting, by the entity, a message to a satellite, the message instructing the satellite to increase a power level associated with transmissions to the earth-based terminals.

43. A method of generating an initial carrier-to-noise (C/N) value used in estimating a clear sky C/N value, comprising:
determining a link budget for transmissions from a satellite to a plurality of earth-based terminals, the link budget being based on a carrier level associated with transmissions from the satellite to the earth-based terminals and at least one of a noise level and interference level associated with transmissions from the satellite to the earth-based terminals; and
subtracting a predetermined value from the link budget to generate the initial value.

44. The method of claim 43, further comprising:
initializing a filtering process with the initial value, wherein the filtering process is used to estimate the clear sky C/N value.

45. The method of claim 43, wherein the determining a link budget comprises dividing the carrier level by the sum of the noise level and interference level

46. The method of claim 43, wherein the initial value is 5.5 dB.

47. The method of claim 43, wherein the predetermined value ranges from 1-3 dB.
